(19) United States
(12) Patent Application Publication
(10) Pub. No.: US 2014/0020845 A1
(43) Pub. Date: Jan. 23, 2014

(54) Method For Debonding Items With Reactive Multilayer Foil

(71) Applicant: Thermal Conductive Bonding, Inc., San Jose, CA (US)

(72) Inventors: Ryan A. Scatena, Gilroy, CA (US); Andrew P. Stack, San Jose, CA (US); Joseph A. Simpson, Morgan Hill, CA (US)

(73) Assignee: Thermal Conductive Bonding, Inc., San Jose, CA (US)

(21) Appl. No.: 13/946,991

(22) Filed: Jul. 19, 2013

Related U.S. Application Data
(60) Provisional application No. 61/674,250, filed on Jul. 20, 2012.

(51) Int. Cl. B32B 7/10

(52) U.S. Cl. CPC B32B 7/10
USPC 156/701; 428/411.1; 428/447; 428/457; 428/426; 428/413

(57) ABSTRACT

An apparatus comprising a first substrate, a second substrate, a bonding layer positioned between the first substrate and the second substrate, the bonding layer holding the first substrate and the second substrate together, and a reactive layer embedded in the bonding layer. The reactive layer can generate sufficient thermal energy to cause the first substrate to separate from the second substrate without damaging at least one of the first substrate or the second substrate when the reactive layer is activated, and is preferably comprised of a reactive multilayer foil.

This application claims the benefit of U.S. provisional application 61/674,250, filed Jul. 20, 2012, which is incorporated herein by reference.

### BACKGROUND OF THE INVENTION

Reactive multilayer foils are foils comprised of alternating thin layers of certain materials, such as aluminum and nickel. The preparation of a reactive multilayer foil was described in U.S. Pat. No. 6,534,194, issued on Mar. 18, 2003 and originally assigned to Johns Hopkins University. Reactive multilayer foils made from other materials, such as alternating aluminum and titanium layers or titanium and amorphous silicon layers are also known.

Aluminum/nickel reactive multilayer foils are commercially available from companies such as Indium Corporation under the trademark NanoFoil®. According to information provided on Indium Corporation's website, the NanoFoil® brand reactive multilayer foil is manufactured using a vapor deposition process to build up thousands of alternating layers of aluminum and nickel. In contrast, the Johns Hopkins patent describes a manufacturing technique that involves pressing the layers together.

The reactive multilayer foil is activated using a small pulse of energy from a thermal, electrical or optical source. Once activated, the reactive multilayer foil undergoes an exothermic reaction that releases a burst of localized heat. The heat generated by the reactive multilayer foil is used in numerous ways, such as in reaction initiation processes and in joining applications. For example, the heat from the reactive multilayer foil can be used to reflow solder to form a high strength bond.

The use of epoxies and elastomeric materials to attach components in the semiconductor manufacturing and related industries is well known in the art. For example, U.S. Pat. No. 6,194,322 describes an electrode for use in a plasma reaction chamber that is bonded to a support member using an elastomer. Similarly, U.S. published patent application number US 2006/0272941 A1 (published Dec. , 2006), describes a methodology for manufacturing large area sputtering target assemblies in which the sputtering target is held to the backing plate with an elastomer. As new bonding techniques are developed for semiconductor manufacturing processes, the use of reactive multilayer foils should be explored.

### SUMMARY OF THE INVENTION

Briefly, the present invention comprises an item comprised of a first substrate, a second substrate, a bonding layer positioned between the first substrate and the second substrate, and a reactive layer embedded in the bonding layer. The reactive layer can be a piece of reactive multilayer foil such as NanoFoil® brand reactive foil. The bonding layer holds the first substrate and the second substrate together and the reactive layer can generate a controlled force sufficient to separate the first substrate from the second substrate without damaging at least one of the first substrate or the second substrate. A method for using the present invention comprises debonding the item by igniting the reactive layer embedded in the bonding layer.

### BRIEF DESCRIPTION OF THE SEVERAL VIEWS OF THE DRAWINGS

FIG. 1 is a cross-sectional view of an item with a reactive debonding layer according to the present invention;

FIG. 2 is a top view of the item according to the present invention; and

FIG. 3 is a cross-sectional view of an item with a reactive debonding layer and a recessed fuse according to the present invention.

### DETAILED DESCRIPTION OF THE INVENTION

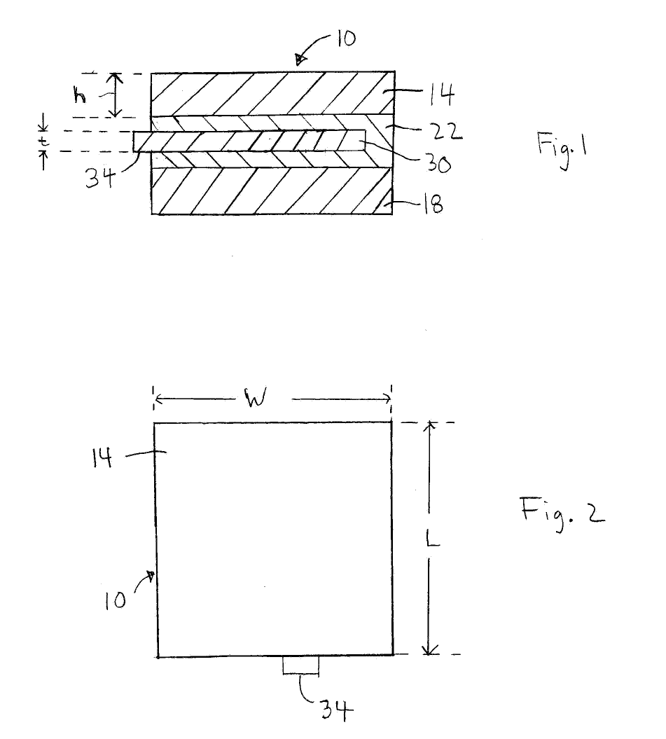

FIG. 1 illustrates an item 10 that comprises a first substrate 14, a second substrate 18, to a bonding layer 22 and a reactive layer 30. The bonding layer 22 functions to attach the substrates 14 and 18 firmly together so that they can perform some function. The reactive layer 30 provides a means for separating the substrates 14 and 18 at some time after they have been attached to each other by the bonding layer. The reactive layer 30 has a thickness “t.” In a preferred embodiment, the substrates 14 and 18 each have a thickness “h” as illustrated in FIG. 1 for the first substrate 14. The thickness “h” for the first substrate 14 may be the same or different than the thickness “h” for the second substrate 18.

An optional feature of the item 10 is an exposed fuse 34 that extends from an edge of the item 10 and provides a means for igniting the reactive layer 30. In a preferred embodiment, the exposed fuse 34 is a segment of the reactive layer 30 that extends from the edge of the item 10. In a preferred embodiment, the exposed fuse 34 is a segment of the reactive layer 30 that extends outside of the bonding layer 22. The exposed fuse can be used to activate the reactive layer 30.

In a preferred embodiment, the reactive layer 30 comprises a piece of a reactive multilayer foil comprised of alternating thin layers of aluminum and nickel. A suitable reactive multilayer foil for use as the reactive layer 30 is the commercially available NanoFoil® brand of reactive multilayer foil marketed by Indium Corporation. Reactive multilayer foils made from other materials could also be used.

In a preferred embodiment, the first substrate 14 and the second substrate 18 are both comprised of aluminum and are rectangular in shape. However, the first substrate 14 and the second substrate 18 can be comprised of other materials, such as ceramics, metals and alloys, and can have other shapes. Additionally, the first substrate 14 and the second substrate 18 do not need to be comprised of the same material. The first substrate 14 can be comprised of the same material or of a different material than the second substrate 18. The specific shapes of the first substrate 14 and the second substrate 18 are not relevant to the present invention, but for illustrative purposes other shapes that can be used include cylindrical, triangular and polyhedral shapes, as well as other shapes.

The bonding layer 22 can be comprised of many types of materials that have a bond strength great enough to hold the substrates 14 and 18 together for their intended purpose. However, in a preferred embodiment, the bonding layer 22 is comprised of an epoxy or an elastomer. As used herein, the term “epoxy” is used to mean the general class of thermosetting polymers formed from the reaction of an epoxide resin with a hardener, such as a polyamine. Representative epoxy compounds that are used in the present invention include the epoxy sold by Henkel KGaA under the trademark Loctite Hysol 1-C and the epoxy sold by Resinlab (Ellsworth Corporation) under the trademark ResinLab EP 1046FG.

In general, an elastomer is a substance (preferably a polymer) having elastic properties. A preferred type of elastomer that can be used in the bonding layer 22 is a silicone elastomer, such as the poly(dimethylsiloxane) elastomer sold by Dow Corning under the trademark Sylgard® 184 brand silicone elastomer. Poly(dimethylsiloxane) elastomer (PDMS) is a silicone elastomer comprised of a Si—O—Si backbone with each silicon atom bearing two methyl (Me) groups, and is typically denoted as (Me₂SiO)ₙ.

Other types of elastomers that can be used in the elastomer layer 22 are the fluoroelastomers referred to as FKMs (also known as FPMs) and the perfluoroelastomers, referred to as FFKMs (also known as FFPMs). FKMs have very good resistance to heat and chemicals and are sold commercially under trademarks such as Viton™, Dai-El™, Dyneon™ and Tecnoflon™).

FFKMs are terpolymers comprised of tetrafluoroethylene (CF₂=CF₂), and usually PMVE and another monomer. FFKMs are sold commercially under trademarks such as Chemraz™ and Kalrez™.

Many other types of elastomers can be used in the bonding layer 22, including polyimide, polyketone, polyetherketone, polyether sulfone, polyethylene terephthalate, and fluroethylene propylene copolymers. Flexible epoxy or rubber can also be used Other silicone elastomers that can be used include the products marketed as General Electric RTV 31 and General Electric RTV 615 brand silicone elastomers.

FIG. 2 illustrates the item 10 in more detail. In a preferred embodiment, the item 10 is rectangular or square in shape and has a width W and a length L. The width W and a length L may be adjusted according to the specific use of the item 10. However, in a representative example, the width W and the length L are both approximately 1.5 inches, and the substrates 14 and 18 each have a thickness “h” of approximately 0.25 inches. FIG. 2 also illustrates that the exposed fuse 34 extends from an edge of the item 10 by a small distance and provides a region of the reactive layer 30 that is outside of the item 10 that is used to ignite the reactive layer 30. In a representative example, the thickness “t” of the reactive layer 30 (shown in FIG. 1) is about 60 micrometers (μm). The dimensions W, L, h and t may all be varied or adjusted depending on the nature of the item 10.

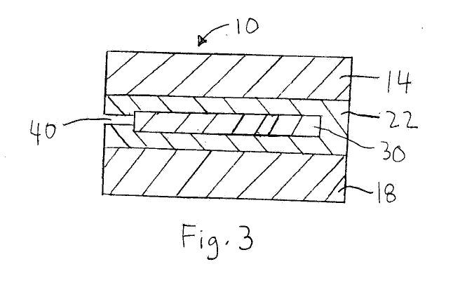

FIG. 3 illustrates a configuration of the item 10 that is the same as the configuration illustrated in FIG. 1 except that the exposed fuse 34 has been replaced by a recessed fuse 40. The recessed fuse 40 is an aperture formed in the bonding layer 22, such as by forming a hole in the bonding layer 22 that allows access to the reactive layer 30. The recessed fuse can be used to activate the reactive layer 30.

In a representative example, the substrates 14 and 18 are comprised of aluminum, the bonding layer 22 comprises an epoxy or an elastomer and the reactive layer 30 comprises the NanoFoil® brand of reactive multilayer foil.

In other examples, the item 10 is a high value item, such as a ceramic electrode, a showerhead electrode or a sputtering target. The substrates 14 and 18 may be comprised of many materials including but not limited to: ceramic materials, such as silicon carbide, alumina and boron nitride; precious metals, including silver, gold and palladium; refractory metals; and other materials, such as silicon, yttria (yttrium oxide), indium and tin oxides and cadmium/tin alloys.

Referring to FIG. 1, in many situations, at some point after the item 10 has been formed, there is a need to take the substrates 14 and 18 apart (i.e. to debond the item 10). Debonding might be necessary to replace or repair one of the substrates 14 or 18 or for some other reason. However, since the materials used in the bonding layer 22 have fairly high bond strengths, it is sometimes difficult or impossible to separate substrates 14 or 18 after they have been joined together by the bonding layer 22. Use of the reactive layer 30 provides a method for debonding the substrates 14 and 18.

To accomplish the debonding, the reactive layer 30 is activated (e.g. ignited) such as by using either the exposed fuse 34 or the recessed fuse 40. If the exposed fuse 34 is used, an ignition source such as a spark, an open flame or an electrical current is applied to the exposed fuse 34. Generally, any suitable type of thermal, electrical or optical activation can be used as the ignition source. Once activated, the reactive layer 30 undergoes an exothermic reaction and reaches a high temperature very quickly. The size and position of the reactive layer is chosen so that the heat and expansion force destroys the bond formed by the bonding layer 22, but does not damage the substrates 14 and 18. After debonding, the substrates 14 and 18 can be separated and cleaned.

If the recessed fuse 40 is used, the ignition source needs to be inserted into the aperture that forms the recessed fuse 40 so that the ignition source makes contact with the reactive layer 30. For example a wire can be inserted into the recessed fuse 40 to make electrical contact with the reactive layer 30.

### EXAMPLE 1

To illustrate the debonding process, the following experiments were conducted. Two aluminum plates having dimensions of approximately 1.5″×1.5″×0.25″ were bonded together using a variety of bonding materials (epoxies or elastomers). The following steps were used in the experiments: 1) a layer of bonding material was placed on a surface of the first aluminum plate; 2) a 60 μm thick piece of NanoFoil® brand reactive multilayer foil was placed on the layer of bonding material on the first aluminum plate; 3) a layer of bonding material was placed on a surface of the second aluminum plate; and 4) the two aluminum plates were brought together so that the layer of bonding material on each plate contacted each other and the piece of NanoFoil® brand reactive multilayer foil was sandwiched between the two plates. A small section of the NanoFoil® brand reactive multilayer foil was allowed to extend outside of the two plates to act as the exposed fuse 34.

The bonding material was allowed to cure as specified by the manufacturer. After the bonding material had cured, the reactive layer was ignited by applying an electric current to the exposed fuse 34. Upon ignition, the two plates were separated by the force and heat generated by the reactive multilayer foil chemical reaction.

In Example 1, two different epoxy compounds and one elastomer compound were used as the bonding materials. In each test only one type of epoxy or elastomer was used as the bonding material at a time (i.e. different epoxies were not used together and epoxies and elastomers were not used together). The two epoxies tested were the Loctite Hysol 1-C epoxy and the ResinLab EP 1046FG epoxy. The elastomer tested was the Sylgard® 184 brand silicone elastomer.

Tensile tests indicated that samples prepared in the manner of Example 1 did not fail when pulled to 500 lbf (pounds of force) or greater than 2000 psi before the reactive layer was ignited. Additionally, it was observed that a small temperature rise occurred in the aluminum plates in the first seconds after ignition. A rough estimate for this particular example using aluminum plates, assuming temperature uniformity in the sample, indicates that 272J would have been added to the test piece or 16 J/cm² of reactive foil area. The uniform temperature assumption overestimates the total energy significantly and makes this estimate more of a worst cast factor. Energy and temperature may also be greatly reduced by using a thinner layer of the reactive foil and/or a larger mass in the aluminum plates.

In one embodiment, the present invention is an item 10 comprised of a first substrate 14, a second substrate 18, a bonding layer 22 positioned between the first substrate and the second substrate, and a reactive layer 30 embedded in the bonding layer. The bonding layer holds the first substrate and the second substrate together and the reactive layer, when activated, can generate a controlled force sufficient to separate the first substrate from the second substrate without damaging at least one of the first substrate or the second substrate. Ideally, neither the first substrate nor the second substrate would be damaged by the controlled force of the reactive layer. However, in some applications, it may be acceptable for one of the substrates to be damaged, such as where one of the substrates is less important or valuable than the other substrate.

A method for using the present invention comprises debonding an item 10 by forming an item 10 comprised of a first substrate 14 attached to a second substrate 18 by a bonding layer 22; and activating a reactive layer 30 embedded in the bonding layer, thereby causing the two substrates 14 and 18 to be separated by the heat generated by the ignition of the reactive layer. The ignition of the reactive layer generates sufficient thermal energy to cause the first substrate to be separated from the second substrate without damaging at least one of the first substrate or the second substrate. The thermal energy from the ignition of the reactive layer probably causes chemical bonds in the bonding layer 22 to be broken, thereby allowing the substrates 14 and 18 to separate.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true scope of the invention.

We claim:

1. An apparatus comprising:
a first substrate;
a second substrate;
a bonding layer positioned between the first substrate and the second substrate, the bonding layer holding the first substrate and the second substrate together; and
a reactive layer embedded in the bonding layer.

2. The apparatus of claim 1 wherein the reactive layer can generate sufficient thermal energy to cause the first substrate to separate from the second substrate without damaging at least one of the first substrate or the second substrate when the reactive layer is activated.

3. The apparatus of claim 1 wherein the bonding layer is selected from the group consisting of epoxies and elastomers.

4. The apparatus of claim 3 wherein the bonding layer comprises a silicone elastomer.

5. The apparatus of claim 3 wherein the bonding layer comprises a thermosetting polymer.

6. The apparatus of claim 1 wherein the reactive layer comprises a reactive multilayer foil.

7. The apparatus of claim 6 wherein the reactive multilayer foil comprises a thin foil comprised of aluminum and nickel.

8. The apparatus of claim wherein the reactive multilayer foil comprises the NanoFoil® brand of reactive multilayer foil.

9. The apparatus of claim 1 wherein the first substrate is comprised of a material selected from the group consisting of aluminum, ceramic materials, precious metals, silicon, yttrium oxide, indium oxide, tin oxide and cadmium/tin alloys.

10. The apparatus of claim 1 wherein the first substrate and the second substrate are parts of an apparatus selected from the group consisting of sputtering targets, showerhead electrodes and ceramic electrodes.

11. An apparatus comprising:
a first substrate;
a second substrate;
a bonding layer positioned between the first substrate and the second substrate, the bonding layer holding the first substrate and the second substrate together; and
a reactive layer comprised of a reactive multilayer foil embedded in the bonding layer.

12. The apparatus of claim 11 wherein the reactive layer can generate sufficient thermal energy to cause the first substrate to separate from the second substrate without damaging at least one of the first substrate or the second substrate when the reactive layer is activated.

13. The apparatus of claim 11 further comprising an exposed fuse comprised of a segment of the reactive layer that extends outside of the bonding layer.

14. The apparatus of claim 11 further comprising a recessed fuse comprised of an aperture in the bonding layer that allows access to the reactive layer.

15. A method comprising:
obtaining an item comprised of a first substrate attached to a second substrate by a bonding layer; and
separating the first substrate from the second substrate by activating a reactive layer embedded in the bonding layer.

16. The method of claim 15 wherein the bonding layer is selected from the group consisting of epoxies and elastomers.

17. The method of claim 15 wherein the reactive layer comprises a reactive multilayer foil.

18. The method of claim 17 wherein the reactive multilayer foil is comprised of aluminum and nickel.
